(19) United States
(12) Patent Application Publication
(10) Pub. No.: US 2010/0002820 A1
(43) Pub. Date: Jan. 7, 2010

(54) MULTISTATION COMMUNICATION APPARATUS

(75) Inventor: Yoshihiro Iwata, Kitakyushu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KABUSHIKI KAISHA YASKAWA DENKI, Kitakyushu-shi, Fukuoka (JP)

(21) Appl. No.: 12/443,876

(22) PCT Filed: Sep. 28, 2007
(86) PCT No.: PCT/JP2007/068918

§ 371 Date: Apr. 1, 2009

(30) Foreign Application Priority Data
Oct. 6, 2006 (JP) 2006-275333

(51) Int. Cl. H04L 7/00

(52) U.S. Cl. 375/356

(57) ABSTRACT

A multistation communication apparatus in which each of a plurality of primary stations (21) is connected to a plurality of secondary stations (91) by a communication channel for each primary station and the transmission from the primary stations (21) to the secondary stations (91) is performed by 1:1. The apparatus can arbitrarily vary a control period for each of the secondary stations connected to the primary stations and also enables the synchronization between the primary stations. The primary stations (21) have means for writing a transmission start flag (721) for starting transmission for each of transmission buffers (31s) corresponding to the secondary stations (91) and means for using a transmission start control signal (7611) of another transmission buffer. Furthermore, the primary stations (21) have means for matching the transmission start timing based on their own transmission start flags with the transmission start timing when synchronized with the another transmission buffer.

### TECHNICAL FIELD

The present invention relates to a multistation communication apparatus capable of performing communication between a plurality of primary stations and a plurality of secondary stations at various control intervals using a predetermined frame format.

### BACKGROUND ART

Conventionally, in a case where a CPU processes a block of data with respect to an I/O device within a constant period, there may be a case where the CPU may access the I/O device via a dual-port RAM. The dual-port RAM is accessed via a local parallel bus interface of the CPU. If there are a plurality of I/O devices, a plurality of dual-port RAMs are necessary, whereby the number of wires arranged on a substrate significantly increases. Moreover, if the I/O devices are arranged on substrates, the number of connector pins between the substrates increases and the area of each substrate increases.

As one existing technology for solving this problem, a multistation communication apparatus is disclosed in Patent Document 1. If the structure thereof is contrasted with the present invention, the structure will be a structure shown in FIG. 4. A CPU 11, a primary station 21 which can be accessed via a local parallel bus 12, and secondary stations 91, 92, and 9n for controlling an I/O device are included in the structure. The primary station 21 includes buffers 31, 32, and 3n corresponding to the secondary stations, and performs serial communication with the secondary stations 91, 92, and 9n.

The primary station 21 and the secondary stations 91, 92, and 9n are connected not via one-to-N multidrop time-division multiplex communication but via one-to-one communication so as to prevent a communication interval from becoming longer and to prevent updating of command data from being delayed as the number of the secondary stations increases.

Each of primary stations performs synchronous communication at the same interval as all the secondary stations in accordance with a synchronization signal output from a port 111 of the CPU 11. Moreover, the synchronization signal is supplied to a plurality of primary stations, and thus all the secondary stations connected to the primary stations perform synchronous communication at the same interval.

[Patent Document 1] Japanese Unexamined Patent Application Publication No. 2005-51700 (FIG. 2)

### DISCLOSURE OF INVENTION

### Problems to be Solved by the Invention

However, a structure in which the primary stations and secondary stations perform synchronous communication at the same interval, as shown in FIG. 4, is effective in a multi-axis servo system and the like that control all axes at the same interval; however, such a structure has a problem in that it cannot be used to realize a multi-axis servo system in which each axis has a different control interval. Moreover, such a structure also has a problem in that it cannot be used to connect general-purpose I/O devices, each of which is controlled at a different control interval.

### Means for Solving the Problems

In order to solve the above-described problems, the present invention has a structure described below. An invention described in claim 1 is a multistation communication apparatus including: a CPU and a plurality of primary stations controlled by the CPU, each of the primary stations performing one-to-one communication with a plurality of secondary stations,

wherein the primary station includes a plurality of transmission buffers and reception buffers corresponding to the plurality of secondary stations, and transmission start timing control means for individually controlling a timing at which transmission is started from each of the plurality of transmission buffers to a corresponding one of the plurality of secondary stations.

An invention described in claim 2 is the multistation communication apparatus according to claim 1, wherein the transmission start timing control means includes a function of starting transmission from the transmission buffer in accordance with a transmission start signal supplied from the CPU and a function of starting transmission from the transmission buffer in synchronization with start of transmission from another transmission buffer.

An invention described in claim 3 is a multistation communication apparatus including: a CPU and a plurality of primary stations controlled by the CPU, each of the primary stations performing one-to-one communication with a plurality of secondary stations, wherein the primary station includes a plurality of transmission buffers and reception buffers corresponding to the plurality of secondary stations, and a transmission control circuit that outputs a plurality of transmission start control signals for individually controlling a timing at which transmission is started from each of the plurality of transmission buffers to a corresponding one of the plurality of secondary stations.

Moreover, an invention of claim 4 is the multistation communication apparatus according to claim 3, wherein the transmission start control circuit includes a transmission start register, a synchronization-signal input/output switching register, a transmission start signal selector, a transmission start delay circuit, and an OR circuit.

Moreover, an invention of claim 5 is the multistation communication apparatus according to claim 4, wherein the transmission start register is a register into which the CPU writes a transmission start flag allocated to one of the transmission buffers.

Moreover, an invention of claim 6 is the multistation communication apparatus according to claim 4, wherein the synchronization-signal input/output switching register is a register into which the CPU writes a synchronization-signal input/output switching signal which is used to set whether the transmission start flag is to be output to a terminal and which is allocated to one of the transmission buffers.

Moreover, an invention of claim 7 is the multistation communication apparatus according to claim 4, wherein the transmission start signal selector is a selector for selecting a primary-station synchronization signal input from the terminal and selects a primary-station synchronization signal input from the terminal when the synchronization input/output switching signal is set in such a manner that the transmission start flag is not output to the terminal, and the transmission start signal selector is one of a plurality of transmission start signal selectors which correspond to the transmission buffers and which are included in the multistation communication apparatus.

Moreover, an invention of claim 8 is the multistation communication apparatus according to claim 4, wherein the transmission start delay circuit is a circuit for generating a transmission start delay signal from the transmission start flag, and the transmission start delay circuit is one of a plurality of transmission start delay circuits which correspond to the transmission buffers and which are included in the multistation communication apparatus.

Moreover, an invention of claim 9 is the multistation communication apparatus according to claim 4, wherein the OR circuit is a circuit for generating the transmission start control signal by performing the logical OR of an output of the transmission start signal selector and the transmission start delay signal, and the OR circuit is one of a plurality of OR circuits which correspond to the transmission buffers and which are included in the multistation communication apparatus.

### Advantages

According to the present invention, transmission can be performed from a plurality of transmission buffers included in a primary station to secondary stations corresponding to the transmission buffers at various intervals different from each other. Moreover, transmission can be performed to the secondary stations from the primary station in synchronization with a transmission buffer of another primary station.

Furthermore, if there are a plurality of transmission buffers, each of which executes transmission to a secondary station at a certain timing, the timings at which transmission is started from the transmission buffers can be precisely synchronized with each other.

Thus, it becomes possible for a secondary station connected to a primary station to be controlled at an interval obtained by multiplying a fundamental interval by an arbitrary integer, and it becomes possible for each of the peripheral I/O devices connected to a CPU to be controlled at an appropriate interval for the peripheral I/O device.

Moreover, a primary station and a secondary station are connected via serial communication. Thus, the amount of wiring on a substrate can be reduced and the number of pins for connectors for connecting substrates can be reduced and the connectors for connecting substrates can be made smaller, whereby the system can be made smaller.

### BRIEF DESCRIPTION OF DRAWINGS

FIG. 1 is a block diagram showing an embodiment of the present invention.

FIG. 2 includes block diagrams showing the embodiment of the present invention.

FIG. 3 is a timing chart showing the embodiment of the present invention.

FIG. 4 is a block diagram showing an existing structure.

FIG. 5 is CASE 1 of synchronization executed in accordance with the present invention.

FIG. 6 is CASE 2 of synchronization executed in accordance with the present invention.

### REFERENCE NUMERALS

11 CPU

12 local parallel bus

13 clock

21 primary station

22 primary station

2n primary station

31s channel-1 transmission buffer

32s channel-2 transmission buffer

3ns channel-n transmission buffer

31r channel-1 reception buffer

32r channel-2 reception buffer

3nr channel-n reception buffer

41 existing transmission control circuit

51 transmission control circuit of the present invention

111 existing primary-station synchronization signal

510 primary-station synchronization signal of the present invention

511 primary-station synchronization signal 1 of the present invention

51n primary-station synchronization signal n of the present invention

61 serial communication

62 serial communication

6n serial communication

70 I/O buffer

71 I/O buffer

81 terminal 1

8n terminal n

91 secondary station

92 secondary station

9n secondary station

410 synchronization-signal input/output switching register

411 channel-1 synchronization input/output switching signal (synchronization input/output switching register, bit 0)

41n channel-n synchronization input/output switching signal (synchronization input/output switching register, bit n)

611 channel-1 transmission start signal selector

61n channel-n transmission start signal selector

720 transmission start register

721 channel-1 transmission start flag (transmission start register, bit 0)

72n channel-n transmission start flag (transmission start register, bit n)

741 channel-1 transmission start delay circuit

74n channel-n transmission start delay circuit

7411 channel-1 transmission start delay signal

741n channel-n transmission start delay signal

7611 channel-1 transmission start control signal

761n channel-n transmission start control signal

C111 through to Cnn3 data to be written into buffer

D111 through to Dnn3 data to be transmitted to secondary station

R111 through to Rnn3 data to be received from secondary station

### BEST MODES FOR CARRYING OUT THE INVENTION

In the following, embodiments of the present invention will be described with reference to the drawings.

### First Embodiment

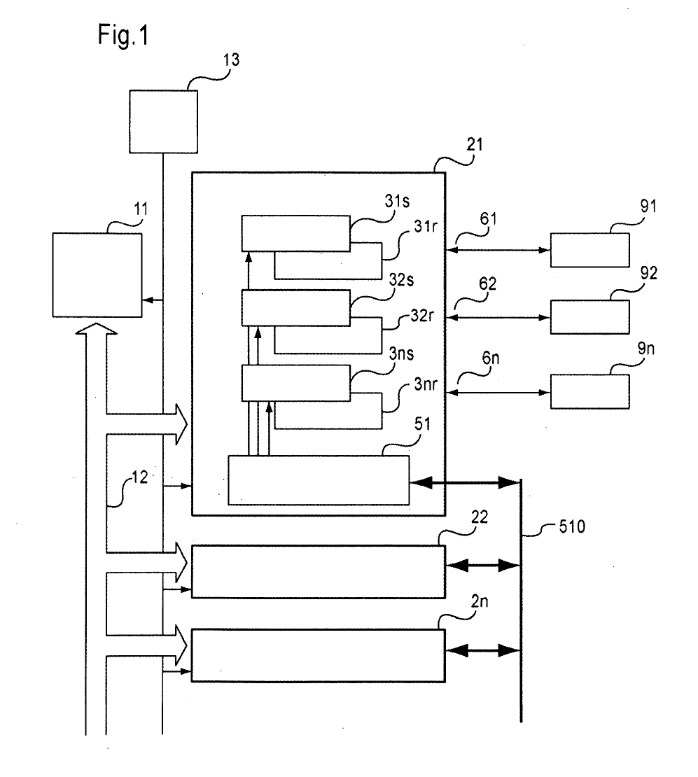

FIG. 1 is a diagram showing an embodiment of the present invention. In FIG. 1, the CPU 11 and primary stations 21, 22, and 2n are connected via the local parallel bus 12. Moreover, the primary station 21 is connected to the secondary stations 91, 92, and 9n through serial communication. The primary station 21 includes a channel-1 transmission buffer 31s and a channel-1 reception buffer 31r corresponding to the secondary station 91, a channel-2 transmission buffer 32s and a channel-2 reception buffer 32r corresponding to the secondary station 92, and a channel-n transmission buffer 3ns and a channel-n reception buffer 3nr corresponding to the secondary station 9n. The primary stations 22 and 2n have a structure similar thereto. Here, a term channel means a line for transmission and reception.

A transmission control circuit 51 is a circuit for controlling start of transmission from each of the transmission buffers 31s, 32s, and 3ns of channels to a corresponding one of the secondary stations. The transmission control circuit 51 can allow the CPU 11 to start transmission from each of the transmission buffers of channels, and can also start transmission from the transmission buffers of channels of a primary station in synchronization with a transmission buffer of a channel of another primary station. A primary-station synchronization signal 510 is a generic name for signals that are output to the outside of the transmission control circuit 51 in order to utilize a transmission start signal of a certain transmission buffer of a certain primary station as a transmission start signal of a transmission buffer of a channel of the certain primary station or of another primary station.

The CPU 11 and each of the primary stations operate in synchronization with a clock 13. Moreover, a control interval of serial communication performed between the primary station and the secondary station is an interval obtained by multiplying a fundamental interval T by an arbitrary integer, the fundamental interval T being generated by an interrupt signal from an internal timer (not shown) of the CPU 11.

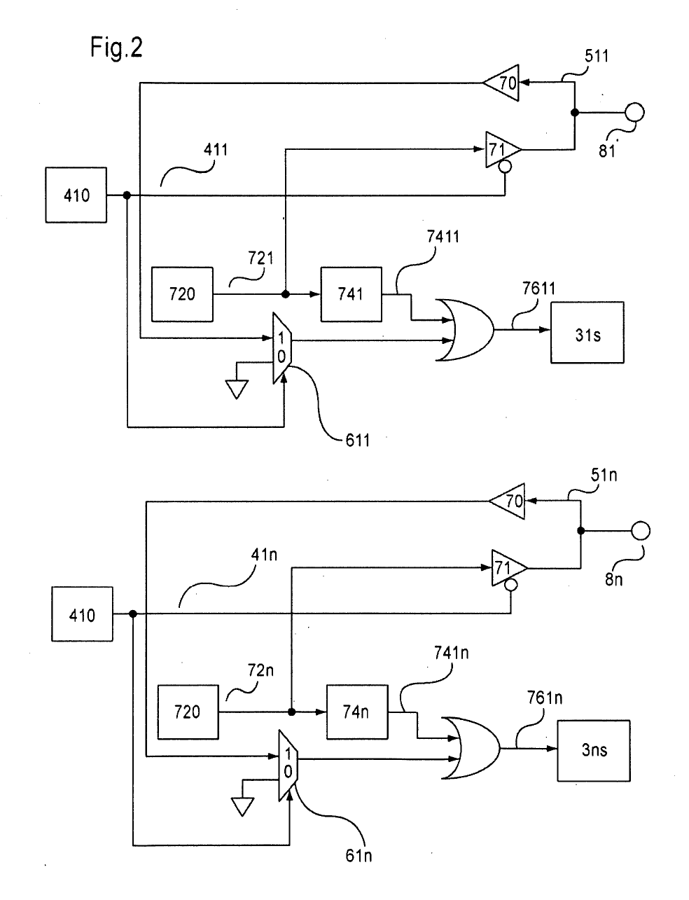

FIG. 2 includes diagrams showing structures of the transmission control circuit 51.

A transmission start register 720 is a register into which a channel-1 transmission start flag 721 for starting transmission from the channel-1 transmission buffer 31s to a corresponding secondary station through to a channel-n transmission start flag 72n for starting transmission from the channel-n transmission buffer 31n to a corresponding secondary station are to be written. In the transmission start register 720, one channel transmission start flag is assigned to one bit. Moreover, all channel transmission start flags are set at the same timing.

A synchronization-signal input/output switching register 410 is a register for individually setting whether each of the channel-1 transmission start flag 721 through to the channel-n transmission start flag 72n should be output to the outside of the transmission control circuit 51. Synchronization input/output switching signals 411 through 41n are assigned to different bits of the synchronization-signal input/output switching register 410. The synchronization input/output switching signals 411 through 41n correspond to the channel-1 transmission start flag 721 through to the channel-n transmission start flag 72n, respectively.

For example, if a channel-1 synchronization input/output switching signal 411 is set to “0”, the channel-1 transmission start flag 721 assigned to bit 0 of the transmission start register is used, via a transmission start delay circuit 741, as a transmission start control signal for the channel-1 transmission buffer 31s, and the channel-1 transmission start flag 721 is also output to a terminal 181.

The channel-1 transmission start flag 721 output to the terminal-1 81 can be utilized as a primary-station synchronization signal for synchronizing start of transmission from transmission buffers of other channels of the same primary station and start of transmission from the channel-1 transmission buffer 31s or for synchronizing start of transmission from each of the transmission buffers of channels of other primary stations and start of transmission from the channel-1 transmission buffer 31s.

In this way, the transmission start delay circuit 741 is a circuit for compensating gate delay, wire delay, and the like in a case where the channel-1 transmission start flag 721 is utilized as a transmission start control signal for the transmission buffers of other channels. The transmission start delay circuit 741 is constituted by a flip-flop. For example, when a delay time is shorter than or equal to one period of the clock 13, the transmission start delay circuit 741 can be constituted by just a single-stage flip-flop. If a delay time is longer than that, the number of stages of a flip-flop is increased in accordance with a necessary delay time. Thus, the timing at which transmission is started from the channel transmission buffer 31s and the timing at which transmission is started from a transmission buffer of a channel which is desired to be synchronized with the channel of the channel transmission buffer 31s can be precisely matched to each other.

If the channel-1 synchronization input/output switching signal 411 is set to “1”, the channel-1 transmission start flag 721 is not output to the terminal 181.

In this case, if the terminal-1 81 is connected using a lead wire, patterning arranged on a substrate, or the like to a terminal from which the channel transmission start flag of a channel for which it is desired to achieve synchronization is output, a channel-1 transmission start signal selector 611 can select a primary-station synchronization signal-1 511 due to the channel transmission start flag of another channel input from the terminal 181.

A channel-1 transmission start control signal 7611 generated using the primary-station synchronization signal-1 511 starts transmission from the channel-1 transmission buffer 31s. Thus, transmission can be performed while the channel-1 transmission buffer 31s is synchronized with other transmission buffers of other channels of the same primary station or with transmission buffers of other channels of other primary stations.

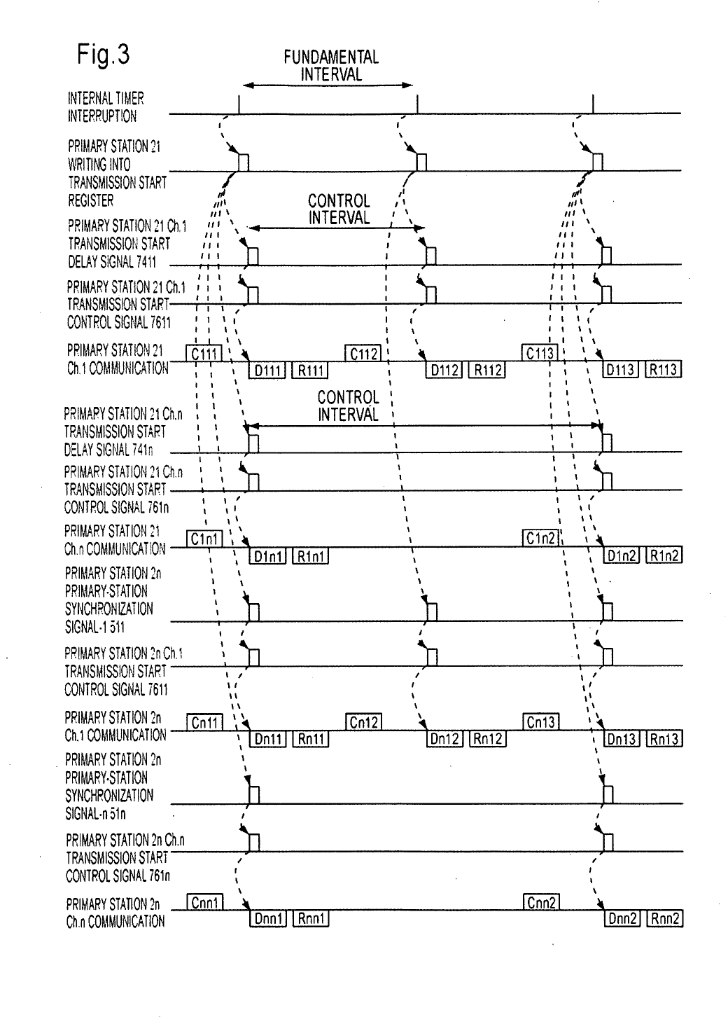

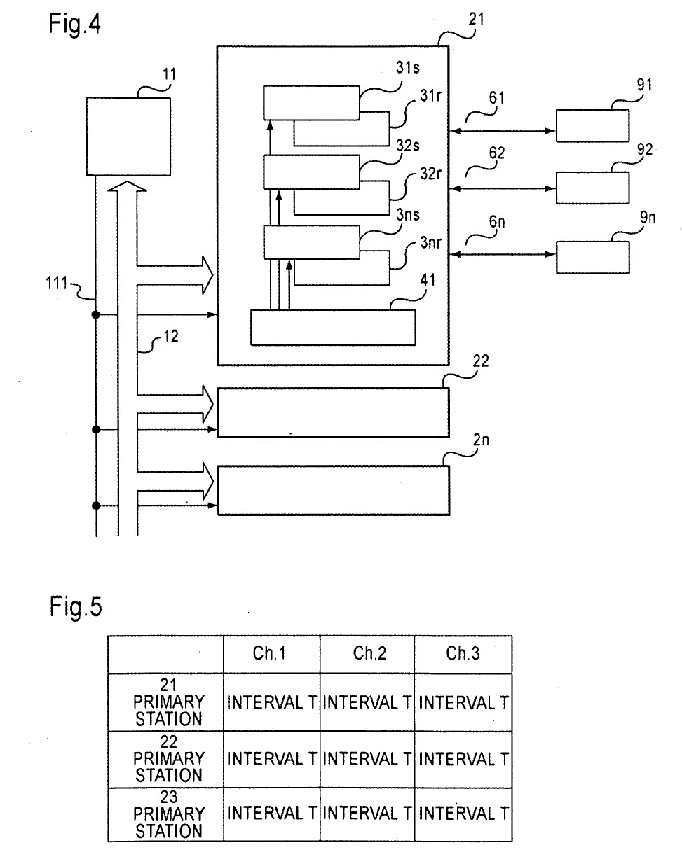

In the above, description has been made using the channel-1 synchronization input/output switching signal 411 as an example; however, other channel-1 synchronization input/output switching signals can be similarly used. Next, using a timing chart of FIG. 3, an operation will be described in a case where transmission from the channel-1 transmission buffer of the primary station 21 is synchronized with transmission from the channel-1 transmission buffer of the primary station 2n at the fundamental interval T, and in a case where transmission from the channel-n transmission buffer of the primary station 21 is synchronized with transmission from the channel-n transmission buffer of the primary station 2n at an interval twice as long as the fundamental interval T. Here, the fundamental interval T is an interval between interruptions from the internal timer (not shown) of the CPU 11.

First, the terminal-1 81 of the primary station 21 is wired to the terminal 181 of the primary station 2n, and a terminal-n 8n of the primary station 21 is wired to a terminal-n 8n of the primary station 2n using a lead wire, patterning arranged on a substrate, or the like.

Next, the channel-1 synchronization input/output switching signal 411 and the channel-n synchronization input/output switching signal 41n of the primary station 21 are set as outputs. This is performed by writing “0” into corresponding bits of the synchronization-signal input/output switching register, the writing being performed by the CPU 11.

Moreover, the channel-1 synchronization input/output switching signal 411 and the channel-n synchronization input/output switching signal 41n of the primary station 2n are set as inputs. This is performed by writing “1” into corresponding bits of the synchronization-signal input/output switching register, the writing being performed by the CPU 11.

First, the CPU 11 sets data to be transmitted to the channel-1 transmission buffer 31s and the channel-n transmission buffer 3ns of the primary station 21 and the channel-1 transmission buffer 31s and the channel-n transmission buffer 3ns of the primary station 2n (C111, C1n1, Cn11, and Cnn1 in FIG. 3).

Upon receiving an interruption from the internal timer, the CPU 11 writes the channel-1 transmission start flag 721 and the channel-n transmission start flag 72n into the transmission start register 720. That is, first, {X (the most significant bit), X, . . . , 1 (nbit), . . . , 1 (0 bit)} is written, and 0 bit corresponds to the channel-1 transmission start flag 721 of the primary station 21 and nbit corresponds to the channel-n transmission start flag 72n of the primary station 21.

Here, a channel-1 transmission start delay signal 7411, a channel-1 transmission start control signal 7611, a channel-n transmission start delay signal 741n, and a channel-n transmission start control signal 761n are generated. Data is transmitted from the channel-1 transmission buffer 31s of the primary station 21 and the channel-n transmission buffer 3ns of the primary station 21 (D111 and D1n1 in FIG. 3). Moreover, the primary-station synchronization signal-1 511, which is a signal from the terminal 181 of the primary station 21, is input to the terminal-1 81 of the primary station 2n. In the primary station 2n, the channel-1 transmission start signal selector 611 selects the primary-station synchronization signal-1 511, and the channel-1 transmission start control signal 7611 is generated. The channel-n transmission start control signal 761n is similarly generated.

The channel-1 transmission buffer 31s of the primary station 2n starts transmission in synchronization with the channel transmission start control signal 7611 and the channel-n transmission buffer 3ns of the primary station 2n starts transmission in synchronization with the channel-n transmission start control signal 761n (Dn11 and Dnn1 in FIG. 3).

In the next interval, the CPU 11 writes {X (the most significant bit), X, . . . , 0 (nbit), . . . , 1 (0 bit)}. Similarly to the previous interval, the channel-1 transmission buffer 31s of the primary station 21 starts transmission (D112 in FIG. 3). At the same timing, the channel-1 transmission buffer 31s of the primary station 2n starts transmission (Dn12 in FIG. 3).

Since such an operation is repeated, the channel-1 transmission buffers 31s of the primary stations 21 and 2n perform communication at a control interval of fundamental interval T and the channel-n transmission buffers 3ns of the primary stations 21 and 2n perform communication at a control interval twice as long as the fundamental interval T.

Here, in FIG. 3, C111, C1n1, Cn11, Cnn1, and the like represent writing into the transmission buffers of channels of the primary stations 21 and 2n, and D111, D1n1, Dn11, Dnn1, and the like represent transmission performed to the secondary stations from the transmission buffers of channels of the primary stations 21 and 2n.

Moreover, R111, Rn11, R1n1, Rnn1, and the like represent reception of data transmitted to a primary station in a case where a secondary station completes reception from the primary station when communication is performed in a half-duplex communication mode between the primary and secondary stations. When the primary station completes reception from the secondary station, the primary station interrupts the CPU 11, which is not shown, and sends a notification of the reception thereto.

Next, various synchronization examples will be described in a case where there are three primary stations and each of the primary stations includes transmission buffers for three channels.

FIG. 5 shows a control interval in a case where all transmission buffers of channels of each of the primary stations operate while being synchronized with each other at the same interval, and the control interval is the fundamental interval T in this case.

This can be realized in such a manner that each of the channel synchronization input/output signals of a synchronization-signal input/output switching register of each primary station is set to “0” and a writing operation for setting “1” to corresponding channel transmission start flags of the transmission start register 720 is performed every time an interrupt occurs from the internal timer.

Alternatively, this can be realized by the following: first, the terminal-1 81 of the primary station 21 is connected to, from among transmission buffers of the primary station 21 and other primary stations, a terminal corresponding to the transmission buffer of a channel for which it is desired to achieve synchronization; next, the channel-1 synchronization input/output signal 411 of the synchronization-signal input/output switching register of the primary station 21 is set to “0” and other channel synchronization input/output switching signals of the primary station 21 and channel synchronization input/output switching signals of the primary stations 21 and 22 are set to “1”; then, every time an interrupt occurs from the internal timer, a writing operation for setting “1” to the channel-1 transmission start flag of the primary station 21 is performed into the transmission start register 720.

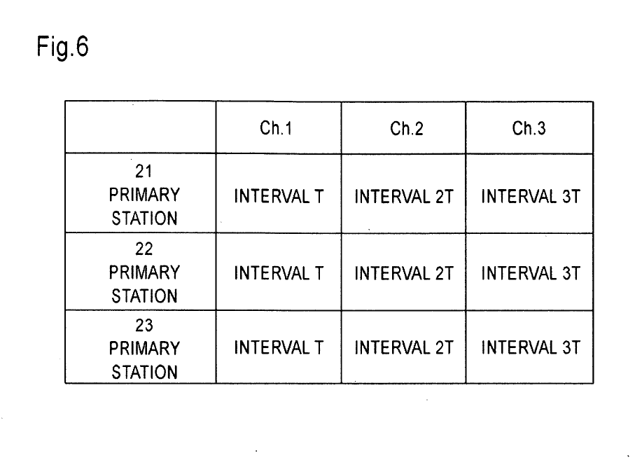

FIG. 6 shows a control interval in a case where the transmission buffers of channels corresponding to each of the primary stations operate at the same interval.

In order to realize this operation, first, the terminal-1 81 of the primary station 21 is connected to a terminal-1 81 of the primary station 22 and a terminal-1 81 of a primary station 23, a terminal-2 62 of the primary station 21 is connected to a terminal-2 62 of the primary station 22 and a terminal-2 62 of the primary station 23, and a terminal-3 63 of the primary station 21 is connected to a terminal-3 63 of the primary station 22 and a terminal-3 63 of the primary station 23. Next, the CPU 11 sets each of the channel synchronization input/output signals of the synchronization-signal input/output switching register of the primary station 21 to “0” and each of channel synchronization input/output signals of the primary stations 22 and 23 to “1”.

Then, every time an interruption occurs from the internal timer, the CPU 11 performs, into the transmission start register 720, a writing operation for setting the channel-1 transmission start flag 721 of the primary station 21 at an interval of T, a channel-2 transmission start flag 722 of the primary station 21 at an interval of 2T, and a channel-3 transmission start flag 723 of the primary station 21 at an interval of 3T.

Here, in this case, a channel-3 transmission buffer 33s of the primary station 22 performs transmission at an interval of 3T; however, if the channel-3 transmission start flag 723 is written into in the transmission start register of the primary station 22 at an interval of T, transmission can be performed at an interval of T. This is because a channel-3 transmission start control signal is generated using the logical OR of a channel-3 transmission start delay signal and a primary-station synchronization signal 3 supplied from the outside.

### INDUSTRIAL APPLICABILITY

In this way, in communication between a plurality of primary stations and a plurality of secondary stations, a multistation communication apparatus according to the present invention can make transmission from transmission buffers of the channels of the primary stations be synchronized with each other at various intervals whereby applicable to a multi-axis control system in which various synchronization patterns need to be performed.

1. A multistation communication apparatus comprising: a CPU and a plurality of primary stations controlled by the CPU, each of the primary stations performing one-to-one communication with a plurality of secondary stations,
wherein the primary station includes a plurality of transmission buffers and reception buffers corresponding to the plurality of secondary stations, and transmission start timing control means for individually controlling a timing at which transmission is started from each of the plurality of transmission buffers to a corresponding one of the plurality of secondary stations.

2. The multistation communication apparatus according to claim 1, wherein the transmission start timing control means includes a function of starting transmission from the transmission buffer in accordance with a transmission start signal supplied from the CPU and a function of starting transmission from the transmission buffer in synchronization with start of transmission from another transmission buffer.

3. A multistation communication apparatus comprising: a CPU and a plurality of primary stations controlled by the CPU, each of the primary stations performing one-to-one communication with a plurality of secondary stations,
wherein the primary station includes a plurality of transmission buffers and reception buffers corresponding to the plurality of secondary stations, and a transmission start control circuit that outputs a plurality of transmission start control signals for individually controlling a timing at which transmission is started from each of the plurality of transmission buffers to a corresponding one of the plurality of secondary stations.

4. The multistation communication apparatus according to claim 3, wherein the transmission start control circuit includes a transmission start register, a synchronization-signal input/output switching register, a transmission start signal selector, a transmission start delay circuit, and an OR circuit.

5. The multistation communication apparatus according to claim 4, wherein the transmission start register is a register into which the CPU writes a transmission start flag allocated to one of the transmission buffers.

6. The multistation communication apparatus according to claim 4, wherein the synchronization-signal input/output switching register is a register into which the CPU writes a synchronization input/output switching signal which is used to set whether the transmission start flag is to be output to a terminal and which is allocated to one of the transmission buffers.

7. The multistation communication apparatus according to claim 4, wherein the transmission start signal selector is a selector for selecting a primary-station synchronization signal input from a terminal and selects a primary-station synchronization signal input from the terminal when the synchronization input/output switching signal is set in such a manner that the transmission start flag is not output to the terminal, and the transmission start signal selector is one of a plurality of transmission start signal selectors which correspond to the transmission buffers and which are included in the multistation communication apparatus.

8. The multistation communication apparatus according to claim 4, wherein the transmission start delay circuit is a circuit for generating a transmission start delay signal from the transmission start flag, and the transmission start delay circuit is one of a plurality of transmission start delay circuits which correspond to the transmission buffers and which are included in the multistation communication apparatus.

9. The multistation communication apparatus according to claim 4, wherein the OR circuit is a circuit for generating the transmission start control signal by performing the logical OR of an output of the transmission start signal selector and the transmission start delay signal, and the OR circuit is one of a plurality of OR circuits which correspond to the transmission buffers and which are included in the multistation communication apparatus.
